(19) United States
(12) Patent Application Publication
(10) Pub. No.: US 2025/0187828 A1
(43) Pub. Date: Jun. 12, 2025

(54) SERVICE TROLLEY, AN AUTOMATED STORAGE AND RETRIEVAL SYSTEM COMPRISING THE TROLLEY, AND METHOD OF OPERATING THE TROLLEY

(71) Applicant: AutoStore Technology AS, Nedre Vats (NO)

(72) Inventors: Trond Austrheim, Etne (NO); Ivar Fjeldheim, Haugesund (NO); Simen Aarseth, Stavanger (NO); Magne Hatteland, Stavanger (NO); Kjell Tore Klungland, Etne (NO)

(21) Appl. No.: 18/846,561

(22) PCT Filed: Mar. 13, 2023
(86) PCT No.: PCT/EP2023/056279

§ 371 Date: Sep. 12, 2024

(30) Foreign Application Priority Data
Mar. 15, 2022 (NO) 20220321

(51) Int. Cl. B65G 1/04; B65G 1/06

(52) U.S. Cl. CPC B65G 1/0464; B65G 1/065; B65G 2207/40

(57) ABSTRACT

It is described a trolley (50) for operation on an automated storage and retrieval system (1) comprising a two-dimensional rail system (108) comprising a first set of parallel rails (110) and a second set of parallel rails (111) in the horizontal plane arranged perpendicular to the first set of parallel rails (110) to guide movement of container handling vehicles. The trolley (50) comprises a trolley frame (51), a first set of wheels (42a) for interaction with the rails (110) in the first direction (X) and a second set of wheels (42b) for interaction with the rails (111) in the second direction (Y), a wheel lift mechanism operable between a first position in which the first set of wheels (42a) is above the second set of wheels (42b) such that the second set of wheels (42b) is in contact with the rail system (108), and a second position in which the first set of wheels (42a) is below the second set of wheels (42b) such that the first set of wheels (42a) is in contact with the rail system (108), and an actuator assembly (60) manually operable by a human operator (10) for actuating the wheel lift mechanism (70) between the first position and the second position. It is further described an automated storage and retrieval system (1) comprising the trolley (50), as well as a method of operating the trolley (50).

The present invention relates to trolley for operation on an automated storage and retrieval system, an automated storage and retrieval system comprising the trolley, as well as a method of operating the trolley.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the first direction X and in the second direction Y, respectively. In FIGS. 2, 3 and 4 two wheels in each set are fully visible. The first set of wheels 201b,301b,401b is arranged to engage with two adjacent rails of the first set of parallel rails 110 and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 27 suspended from lifting bands 25. The lifting bands 25 may provide power and communication between the container handling vehicle and the lifting frame 27. The lifting frame 27 may comprise gripping engaging devices 26 for connection to gripping recesses of a storage container 106.

Conventionally, and also for the purpose of this application, Z=1 identifies the uppermost layer available for storage containers below the rails 110,111 i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the first direction X and the second direction Y which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. a first direction X) may comprise one track and each rail in the other, perpendicular direction (e.g. a second direction Y) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both the first direction X and the second direction Y.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Today operators use a wheel-chair to move on top of the grid. Alternatively, the operator may walk on top of the grid.

However, the wheel-chair is complex and non-practical to use, and walking may be dangerous in terms of risk of injury due to falling.

One objective of the invention is to provide a solution which render possible movement around top of the rail system in a safe and easy way.

### SUMMARY OF THE INVENTION

The present invention is set forth and characterized in the independent claims, while the dependent claims describe other characteristics of the invention.

The invention is simpler, faster and safer than walking on top of the rail system.

It is described a trolley for operation on an automated storage and retrieval system, the automated storage and retrieval system comprising a two-dimensional rail system comprising a first set of parallel rails in a horizontal plane arranged to guide movement of container handling vehicles in a first direction across the top of a frame structure, and a second set of parallel rails in the horizontal plane arranged perpendicular to the first set of parallel rails to guide movement of the container handling vehicles in a second direction (Y) which is perpendicular to the first direction, wherein the trolley comprises:
a trolley frame;
a first set of wheels for interaction with the rails in the first direction and a second set of wheels for interaction with the rails in the second direction, wherein the first set of wheels and the second set of wheels are connected to the trolley frame;—a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system; and
an actuator assembly manually operable by a human operator for actuating the wheel lift mechanism between the first position and the second position.

The wheel lift mechanism is also known as track shift mechanism in the art.

The human operator operates the actuator assembly directly.

The trolley is preferably an operator transportation trolley which can be used in transporting an operator. In other words, the trolley has space for an operator to be transported thereon.

The rail system can be a grid-based horizontal rail system, i.e. the rails are horizontal and they cross at regular intervals in the same horizontal plane defining a grid.

The first set of wheels and the second set of wheels may be non-motorized. In other words, all of the wheels of the trolley may be non-motorized wheels for guiding and supporting the trolley on the first and second set of parallel rails. The non-motorized wheels may thus also be seen as guiding wheels.

The trolley frame may be a wheeled base. The first set of wheels, the second set of wheels, the wheel lift mechanism, and at least parts of the actuator assembly may be connected to the wheeled base.

The actuator assembly may comprise a lever. In one aspect, the lever can be a lever arm. The lever or lever arm may actuate the wheel lift mechanism between the first position and the second position. Alternatively, the actuator assembly can comprise a pedal or other device providing the required function of actuating the wheel lift mechanism between the first position and the second position.

The lever or lever arm may extend upwardly from the trolley frame.

The lever arm preferably comprises a handle or similar for the operator to operate the lever arm. The handle may be in one end of the lever arm.

The lever or lever arm may form an angle between 45 degrees and 135 degrees relative a horizontal plane. More preferably, the angle may be between 60 degrees and 120 degrees. However, in any case it will be preferable if the whole lever or lever arm, when the wheel lift mechanism is in both the first position and in the second position, is within a vertical projecting of the trolley frame.

The actuator assembly may comprise an actuator gear and the lever arm may be connected to the actuator gear.

In order to change direction between X and Y on the grid, the trolley may be equipped with a lever arm connected to a gear arrangement for operating the wheel lift mechanism.

The wheel lift mechanism may comprise a wheel lift gear engaged with the actuator gear. This engagement ensures that upon rotation of the actuator gear, the wheel lift gear rotates together with the actuator gear.

The actuator gear has a larger gear circumference than the wheel lift gear. This results in that the wheel lift gear rotates a larger number of degrees than the actuator gear. For example, the actuator gear may have a gear circumference which is three times the size of the wheel lift gear such that upon movement of the actuator gear 60 degrees, the wheel lift gear is rotated 180 degrees.

The actuator assembly may comprise a first end stop representing the first position of the wheel lift mechanism and a second end stop representing the second position of the wheel lift mechanism.

The first and second end stops can be physical stops for stopping linear or angular/rotational movement of e.g. a lever, a lever arm, a rotation stop or similar.

The wheel lift mechanism may comprise:
a coupling link;
a first rocker link connecting the coupling link and the trolley frame;
a second rocker link connecting the coupling link and the trolley frame;
a pivot link connecting the coupling link and the wheel lift gear;
a first shaft extending between a first wheel and a second wheel of the second set of wheels;
a second shaft extending between a third wheel and a fourth wheel of the second set of wheels;
   wherein both the first rocker link and the second rocker link may be pivotally connected to the coupling link and pivotally connected to the trolley frame, and wherein the first rocker link may be fixedly connected to a first end portion of the first shaft and the second rocker link may be fixedly connected to a first end portion of the second shaft.

This ensures that the first shaft and the second shaft follow any movement up and down of the coupling link.

The wheel lift mechanism may comprise:
a first bracket fixedly connected to a second end portion of the first shaft and pivotally connected to the trolley frame;
a second bracket fixedly connected to a second end portion of the second shaft and pivotally connected to the trolley frame.

This is performed in order to synchronize wheel lift movement of the wheels of the second set of wheels.

The pivot link may comprise a first link and a second link, and the first link may be pivotally connected to the wheel lift gear in a first end and pivotally connected to a first end of the second link in a second end, and a second end of the second link may be pivotally connected to the coupling link.

The first link and the second link may rotate together.

The trolley frame may comprise a first stopper for preventing rotation of the pivot link in a first direction, and the first stopper may form the first end stop of the actuator assembly.

A centre axis of the wheel lift gear may extend to an outside of the trolley frame forming a second stopper for preventing rotation of the of the pivot link in a second direction which is opposite to the first direction, and wherein the second stopper may form the second end stop of the actuator assembly. I.e. the centre axis of the wheel lift gear preferably extends outside a vertical projection of the trolley frame such that it can make a physical stopper for the rotation of the pivot link.

The wheel lift mechanism may comprise a self-locking mechanism when in the first position and in the second position.

The first stopper and the second stopper may be arranged such that the first link rotates more than 180 degrees when moving from the first end stop to the second end stop.

A first linear axis may extend between a connection point between the second link and the coupling link and a connection point between the first link and the second link; and
a second linear axis may extend between the connection point between the first link and the second link and a center axis of the wheel lift gear; and wherein when moving between the first end stop and the second end stop the first linear axis and the second linear axis may cross each other twice.

A first threshold position may be formed when the first linear axis and the second linear axis are in a first parallel position, and a second threshold position may be formed when the second linear axis has rotated 180 degrees relative the first linear axis to a second parallel position.

This avoids that the wheel lift mechanism is unintentionally activated when in the first end stop and in the second end stop.

The self-locking mechanism may be formed by rotating past the center line such that a force has to be applied to move the lever arm out of the first and second end positions and past the first parallel position and/or the second parallel position. When in the respective end positions, a force needs to be applied to move out of the end position and further past the parallel position.

The actuator assembly may comprise an intermediate position between the first position and the second position. When in the intermediate position, a lowermost part of all of the wheels in the first set of wheels and all of the wheels in the second set of wheels may at the same level.

The term “at the same level” shall be understood such that all of the wheels of the trolley are in contact with the underlying rails of the rail system. When all wheels are in contact with the rails or tracks at the same time, stability of the trolley is improved as well as unintentional movement of the trolley is prevented.

In the intermediate position all wheels are in contact with the tracks at the same time improving stability and preventing unintentional movement of the trolley.

The first end stop and the second end stop may be arranged such that movement of the wheel lift mechanism between the first position and the second position occurs inside a vertical projection of the wheeled base.

As indicated above, the actuator assembly may have first and second end stops. The wheel lift mechanism is preferably self-locking in both end stops.

The certain number of degrees may be up to 60 degrees such that the lever arm does not extend outside of the vertical projection of the wheeled base. Alternatively, the actuator assembly can comprise a pedal or other device providing the required function of actuating the wheel lift mechanism between the first position and the second position.

In order for the whole lever arm to be arranged inside the vertical projection of the wheeled base, the length of the lever arm may preferably be chosen such that when the gear is operated the certain number of degrees, an upper end of the lever arm is inside a vertical projection of the wheeled base in all operational positions of the lever arm. This has the effect that a large moment due to “long” lever arm resulting in reduced need for power to perform wheel lift is obtained.

The trolley may comprise a pair of supports on opposite sides of the trolley frame.

The supports may be formed of two vertical bars and a horizontal bar, and of the vertical bars may be connected to the trolley frame at a lower end thereof and to the horizontal bar in an upper end thereof.

The trolley may comprise a support portion for supporting the operator, and the support portion may be arranged between the supports.

The support portion may be a platform.

Alternatively, or additionally, the support portion may be a sitting device or similar for supporting the operator.

The actuator assembly may comprise an actuator motor and a control mechanism for operating the actuator motor.

The actuator motor may be signally connected to the control mechanism.

The control mechanism may comprise one or more operating buttons. The operating buttons are operable by the human operator.

The trolley may comprise a connection for a harness of the operator to the trolley. The harness is a safety measure preventing the operator of the trolley from falling down into the columns below the rail system.

The trolley may comprise a structure, and the structure may comprise the connection for the harness.

The connection for the harness may be a fixed connection point.

The connection point may be a pad or padeye. It may be an eye, padeye or other fixed fastening points on the structure.

The connection for the harness may be a spool or winch.

The connection for the harness may be arranged in an upper part of the structure.

The connection for the harness may be arranged within a vertical projection of the trolley frame.

The connection for the harness may comprise a first connection point and a second connection point arranged at a distance from each other.

It is further described a storage system comprising a frame structure, the frame structure comprising upright members and a two-dimensional rail system arranged across the top of the upright members, the rail system comprises a first set of parallel rails arranged to guide movement of container handling vehicles in a first direction across the top of the frame structure, and a second set of parallel rails arranged perpendicular to the first set of rails to guide movement of the container handling vehicles in a second direction across the top of the frame structure which is perpendicular to the first direction, the first and second sets of parallel rails dividing the rail system into a plurality of access openings in the rail system for lifting and lowering of a storage container between a position above the rail system and a position below the rail system, and wherein the storage system comprises:
a plurality of container handling vehicles the container handling vehicle comprises a first set of wheels for moving the container handling vehicle upon the rail system in the first direction and a second set of wheels for moving the container handling vehicles upon the rail system in the second direction; and
a trolley as defined above.

The frame structure of the automated storage and retrieval system may be constructed in a similar manner to the prior art frame structure described above. That is, the frame structure may comprise a number of upright members, and comprise a first, upper rail system extending in the first direction and the second direction. The upright members may typically be made of metal, e.g. extruded aluminum/aluminium profiles.

The frame structure may comprise storage compartments in the form of storage columns provided between the members wherein goods holders such as storage containers may be stackable in stacks within the storage columns.

The frame structure can be of any size. For example, the frame structure may have a horizontal extent of more than 700×700 columns and a storage depth of more than twelve containers.

The automated storage and retrieval system typically comprises a rail system arranged across the top of the frame structure, on which rail system a plurality of remotely operated container handling vehicles may be operated to raise goods holders from, and lower goods holders into, the storage columns, and also to transport the goods holders above the storage columns. The rail system may comprise a first set of parallel rails arranged in a horizontal plane arranged to guide movement of the remotely operated container handling vehicles a first direction X across the top of the frame structure, and a second set of parallel rails in the same horizontal plane arranged perpendicular to the first set of rails to guide movement of the remotely operated container handling vehicles in a second direction which is perpendicular to the first direction. Goods holders stored in the columns are accessed by the remotely operated container handling vehicles through access openings in the rail system. The remotely operated container handling vehicles can move laterally above the storage columns, i.e. in the horizontal plane (same as the X-Y plane).

The upright members of the frame structure may be used to guide the goods holders during raising of the goods holders out from and lowering of the goods holders into the columns. The stacks of goods holders are typically self-supporting.

In an aspect of the storage system, the trolley may have a footprint equal to two access openings including rails adjacent the occupied access openings. Two access openings including rails adjacent the occupied access openings is also denoted two grid cells. The footprint of the trolley may thus correspond to two grid cells of the rail system.

A grid cell is defined as the cross-sectional area, including width of the rails, between the midpoint of two rails running in the first direction (X) and the midpoint of two rails running in the second direction (Y).

It is further described a method of operating a trolley as defined above on a rail system comprising a first set of parallel rails arranged to guide movement of the trolley in a first direction across the top of a frame structure, and a second set of parallel rails arranged perpendicular to the first set of rails to guide movement of the trolley in a second direction across the top of the frame structure which is perpendicular to the first direction, wherein the method comprises a step of:
operating the actuator assembly thereby actuating the wheel lift mechanism between the first position and the second position, and vice versa.

In an aspect of the method, the step of operating the actuator assembly may comprise operating a lever between a first end stop and a second end stop of the actuator assembly.

The method may comprise:
supporting the operator on the trolley while moving the trolley on top of the rail system; and
gaining speed on the trolley by the operator pushing or kicking on the first or second set of parallel rails which is perpendicular to the direction of travel, while being supported on the trolley.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the storage system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed storage system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIGS. 5A-5D are different side perspective views of a trolley with an operator thereon;

FIG. 6A is a side perspective views of a trolley where a wheel lift mechanism is in a first position in which a first set of wheels is above the second set of wheels such that the second set of wheels is in contact with the rail system;

FIG. 6B is an enlarged side view of section A in FIG. 6A;

FIG. 7 is a side perspective view of a trolley where the wheel lift mechanism is in a second position in which the first set of wheels is below the second set of wheels such that the first set of wheels is in contact with the rail system;

FIG. 8 is a side perspective view of a trolley where the wheel lift mechanism is in an intermediate position between the first position and the second position, wherein in the intermediate position a lowermost part of all of the wheels in the first set of wheels and all of the wheels in the second set of wheels are at the same level;

FIG. 9 is a perspective view from below of an actuator assembly and the wheel lift mechanism of the trolley, the actuator assembly being manually operable by a human operator (10) for actuating the wheel lift mechanism between the first position and the second position;

FIG. 10 is a side perspective view of the trolley of FIG. 8 where the wheel lift mechanism is in the intermediate position;

FIG. 11 is a bottom view of the actuator assembly and the wheel lift mechanism of the trolley;

FIG. 12 is a side perspective view of the trolley where two of the wheels in the first set of wheels have been omitted on purpose to better illustrate details of the different components forming part of the wheel lift mechanism when the wheel lift mechanism is in the first position in which the first set of wheels is above the second set of wheels such that the second set of wheels is in contact with the rail system;

FIG. 13 is a side perspective view of the trolley where two of the wheels in the first set of wheels have been omitted on purpose to better illustrate details of the different components forming part of the wheel lift mechanism when the wheel lift mechanism is in the second position in which the first set of wheels is below the second set of wheels such that the first set of wheels is in contact with the rail system;

FIGS. 14A-14C is a perspective view from below of an operational sequence of an actuator assembly comprising a lever arm used to operate the wheel lift mechanism between the first position as shown in FIG. 14A, via the intermediate position as shown in FIG. 14B, and to the second position as shown in FIG. 14C, where some of the components of the trolley have been omitted on purpose to better illustrate the relationship between the components in the respective first position, second position and intermediate position of the wheel lift mechanism;

FIGS. 15A-15C is a side view of the operational sequence in FIGS. 14A-14C;

FIGS. 16A and 16B show a trolley with an actuator assembly comprising a motor for actuating the wheel lift mechanism;

FIG. 17A is a side perspective view of a trolley with a footprint of 2×3 grid cells, the trolley having a structure with a connection for harness;

FIG. 17B is a side perspective view of the trolley of FIG. 17A with an operator thereon, the operator being secured to the structure with a harness;

FIG. 17C is a similar view as FIG. 17B from an opposite angle;

FIG. 18A is a side perspective view of a trolley with a footprint of 3×3 grid cells, the trolley having a structure with a connection for harness;

FIG. 18B is a side perspective view of the trolley of FIG. 18A with an operator thereon, the operator being secured to the structure with a harness;

FIG. 18C is a similar view as FIG. 18B from an opposite angle;

FIG. 18D is a top view of FIGS. 18B and 18C;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

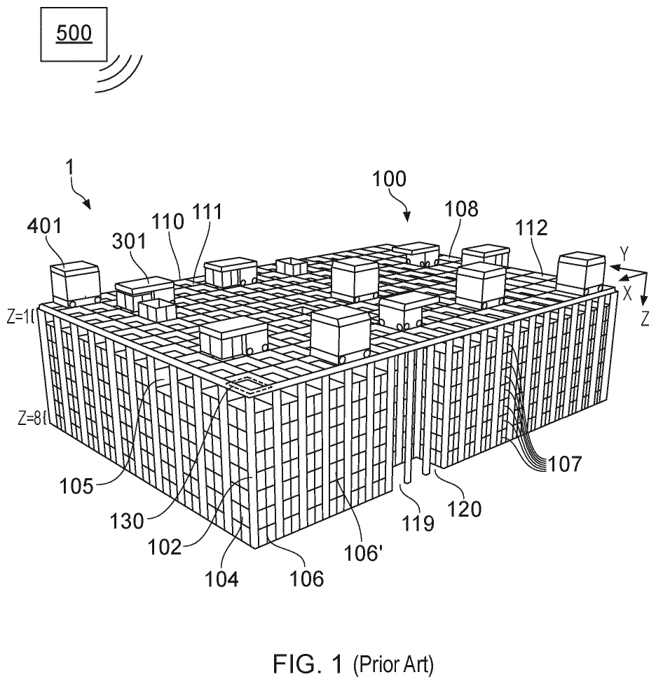

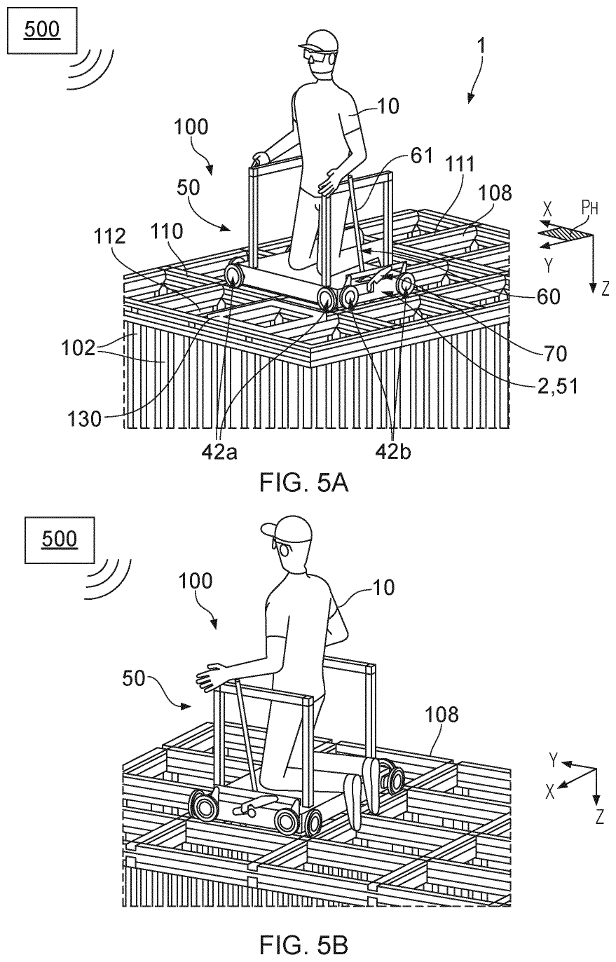

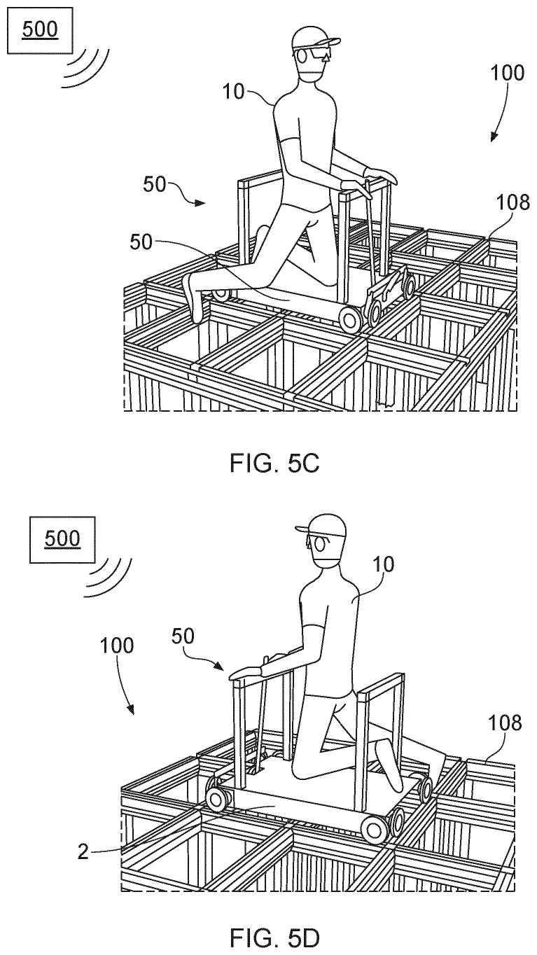

Referring to FIG. 5A, a frame structure 100 of the automated storage and retrieval system 1 may be constructed in a similar manner to the prior art frame structure 100 described above in connection with FIG. 1. That is, the frame structure 100 may comprise a number of upright members 102, and comprise a first, upper rail system 108 extending in the first direction X and the second direction Y. The upright members 102 may typically be made of metal, e.g. extruded aluminum/aluminium profiles.

The frame structure 100 may comprise storage compartments in the form of storage columns 105 provided between the members 102 wherein goods holders such as storage containers 106 may be stackable in stacks 107 within the storage columns 105 (not shown in FIG. 5A, see e.g. FIG. 1).

The frame structure 100 can be of any size. In particular, it is understood that the frame structure can be considerably wider and/or longer and/or deeper than disclosed in FIG. 5A. For example, the frame structure 100 may have a horizontal extent of more than 700×700 columns and a storage depth of more than twelve containers.

The automated storage and retrieval system 1 (see FIG. 1) typically comprises a rail system 108 arranged across the top of the frame structure 100, on which rail system 108 a plurality of remotely operated container handling vehicles 201,301,401 may be operated to raise goods holders from, and lower goods holders into, the storage columns 105, and also to transport the goods holders above the storage columns 105. The rail system 108 comprises a first set of parallel rails 110 arranged in a horizontal plane P_{H} arranged to guide movement of the remotely operated container handling vehicles 201,301,401 a first direction X across the top of the frame structure 100, and a second set of parallel rails 111 in the same horizontal plane P_{H} arranged perpendicular to the first set of rails 110 to guide movement of the remotely operated container handling vehicles 201,301,401 in a second direction Y which is perpendicular to the first direction X. Goods holders stored in the columns 105 are accessed by the remotely operated container handling vehicles 201,301,401 through access openings 112 in the rail system 108. The remotely operated container handling vehicles 201,301,401 can move laterally above the storage columns 105, i.e. in the horizontal plane PH (same as the X-Y plane).

The upright members 102 of the frame structure 100 may be used to guide the goods holders during raising of the goods holders out from and lowering of the goods holders into the columns 105. The stacks 107 of goods holders are typically self-supporting.

FIGS. 5A-5D are different side perspective views of a trolley 50 with an operator 10 thereon. As can be seen from the figures, the operator 10 supports himself on the trolley 50 while moving the trolley 50 on top of the rail system 108 using his feet to gain speed by pushing on one of the first or second set of parallel rails 110,111.

The trolley 50 comprises a first set of wheels 42a and a second set of wheels 42b. In FIG. 5A, only two wheels of the first set of wheels 42a are visible; however, the first set of wheels 42a may typically comprise four wheels. Similarly, only two wheels of the second set of wheels 42b are visible in FIG. 5A; however, the second set of wheels 42b will typically comprise four wheels.

The first set of wheels 42a are configured to move the trolley 50 in the first direction X along two adjacent rails of the first set of rails 110 and the second set of wheels 42b are configured to move the trolley 50 in the second direction Y along two adjacent rails of the second set of rails 111. The first set of wheels 42a and the second set of wheels 42b of the trolley are preferably non-motorized.

The trolley 50 may comprise a vehicle body, wherein an extent of the vehicle body in the first direction, LX, and in the second direction, LY, defines a vehicle body footprint. The size of the trolley 50 shown cover two access openings 112.

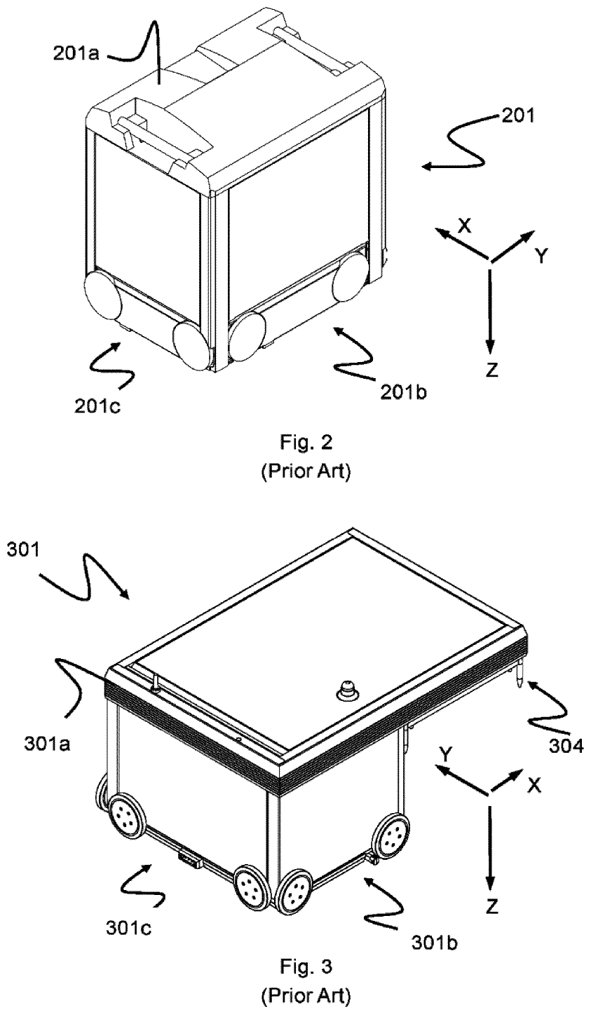

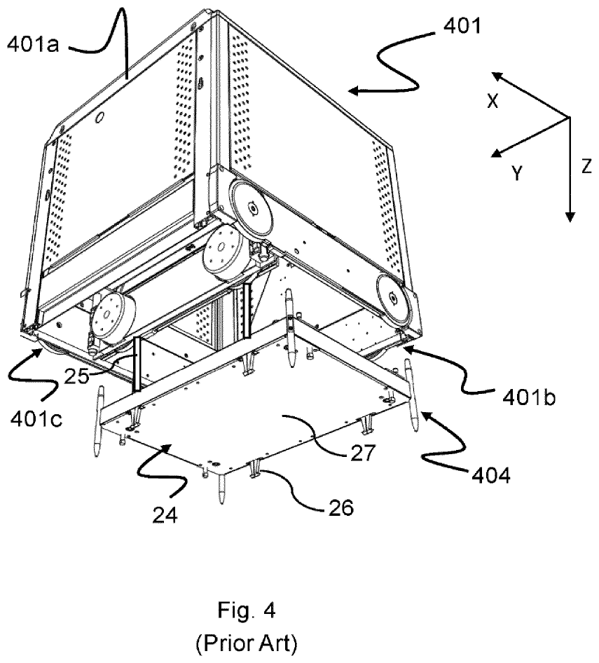

The trolley 50 in FIGS. 5A-5D is configured to be operated on an automated storage and retrieval system 1. The automated storage and retrieval system 1 comprising a two-dimensional rail system 108 comprising a first set of parallel rails 110 in a horizontal plane PH arranged to guide movement of container handling vehicles 201,301,401 (not shown in FIGS. 5A-5D, see e.g. FIGS. 1-4) in a first direction X across the top of a frame structure 100, and a second set of parallel rails 111 in the horizontal plane PH arranged perpendicular to the first set of parallel rails 110 to guide movement of the container handling vehicles 201,301,401 in a second direction Y which is perpendicular to the first direction X.

The trolley 50 is disclosed with a trolley frame 51 and the first set of wheels 42a and the second set of wheels 42b are connected to the trolley frame 51. A wheel lift mechanism 70 is operable between a first position in which the first set of wheels 42a is above the second set of wheels 42b such that the second set of wheels 42b is in contact with the rail system 108, and a second position in which the first set of wheels 42a is below the second set of wheels 42b such that the first set of wheels 42a is in contact with the rail system 108. An actuator assembly 60 manually operable by a human operator 10 for actuating the wheel lift mechanism 70 between the first position and the second position is shown. Details of the wheel lift mechanism 70 and the actuator assembly 60 will be discussed in greater detail below.

The trolley frame 51 can be a wheeled base 2.

The actuator assembly 60 is disclosed with a lever 61 or lever arm 61. The lever arm 61 extends upwardly from the trolley frame 51 (i.e. the wheeled base 2).

The actuator assembly 60 comprises a first end stop representing the first position of the wheel lift mechanism 70 and a second end stop representing the second position of the wheel lift mechanism 70. The first end stop is represented by the maximum allowable movement of the lever arm 61 in a first direction and the second end stop is represented by the maximum allowable movement of the lever arm 61 in a second position which is opposite the first direction.

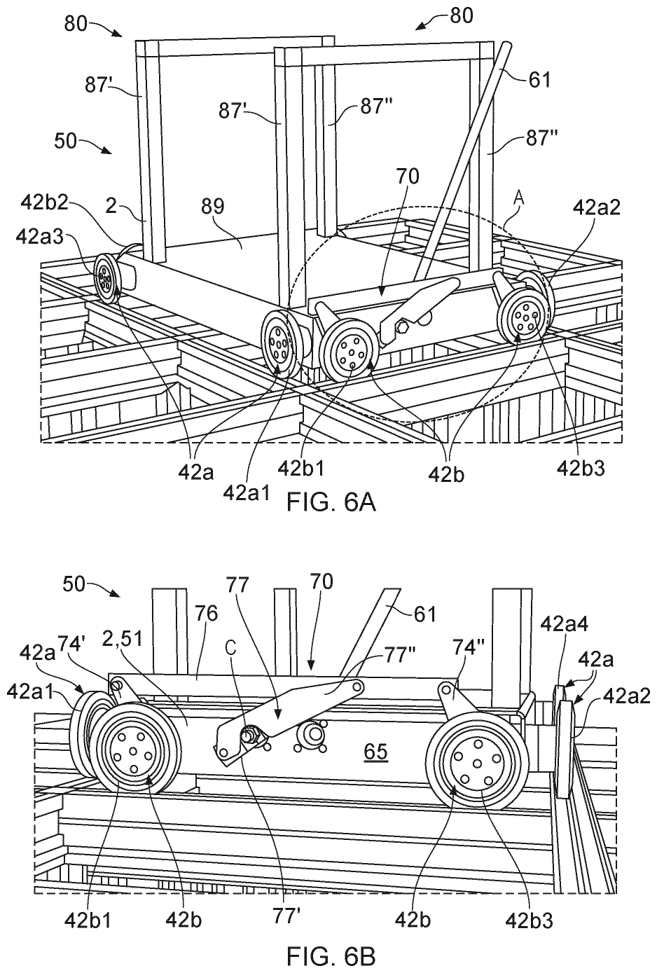

FIG. 6A is a side perspective views of a trolley where a wheel lift mechanism 70 is in a first position in which a first set of wheels 42a is above the second set of wheels 42b such that the second set of wheels 42b is in contact with the rail system 108.

FIG. 6B is an enlarged side view of section A in FIG. 6A.

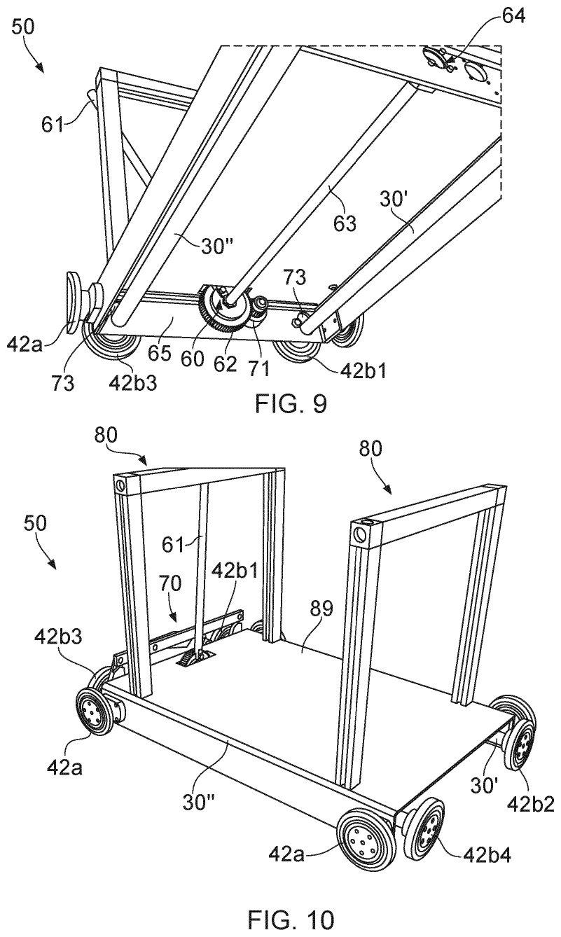

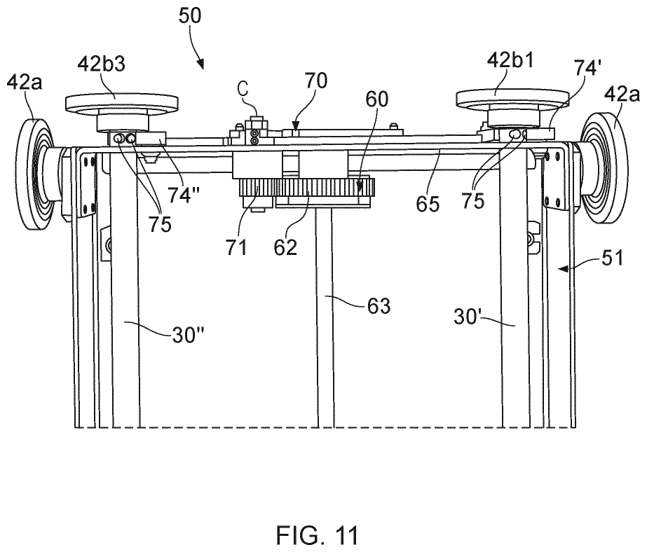

As shown in FIG. 6B the wheel lift mechanism 70 comprises a coupling link 76, a first rocker link 74′, a second rocker link 74″, a pivot link 77 and a wheel lift gear 71 (wheel lift gear 71 is not shown in FIGS. 6A and 6B (see e.g. FIGS. 9, 11) but a centre axis C of the wheel lift gear 71 extends to an outside of the trolley frame 51). The first rocker link 74′ connects the coupling link 76 and the trolley frame 51 and the second rocker link 74″ connects the coupling link 76 and the trolley frame 51. The pivot link 77 connects the coupling link 76 and the centre axis C of the wheel lift gear 71.

The pivot link 77 comprises a first link 77′ and a second link 77″. The first link 77′ is pivotally connected to the wheel lift gear 71 (via the center axis C of the wheel lift gear 71) in a first end and pivotally connected to a first end of the second link 77″ in a second end. A second end of the second link 77″ is pivotally connected to the coupling link 76. The first link 77′ and the second link 77″ rotate together.

The trolley 50 is disclosed with a pair of supports 80 on opposite sides of the trolley frame 51. As shown, the supports 80 are formed of two vertical bars 87′,87″ and a horizontal bar 88, and each of the vertical bars 87′,87″ are connected to the trolley frame 51 at a lower end thereof and to the horizontal bar 88 in an upper end thereof.

The trolley 50 is disclosed with a support portion 89 for supporting the operator 10. The support portion 89 is arranged between the supports 80.

FIG. 7 is a side perspective view of a trolley 50 where the wheel lift mechanism 70 is in a second position in which the first set of wheels 42a is below the second set of wheels 42b such that the first set of wheels 42a is in contact with the rail system 108. When comparing the position of the lever arm 61 in FIG. 7 with the position of the lever arm 61 in FIG. 6A, it can be seen that the lever arm 61 is in two opposite positions, i.e. it has moved from one end position in FIG. 6A to an opposite end position in FIG. 7.

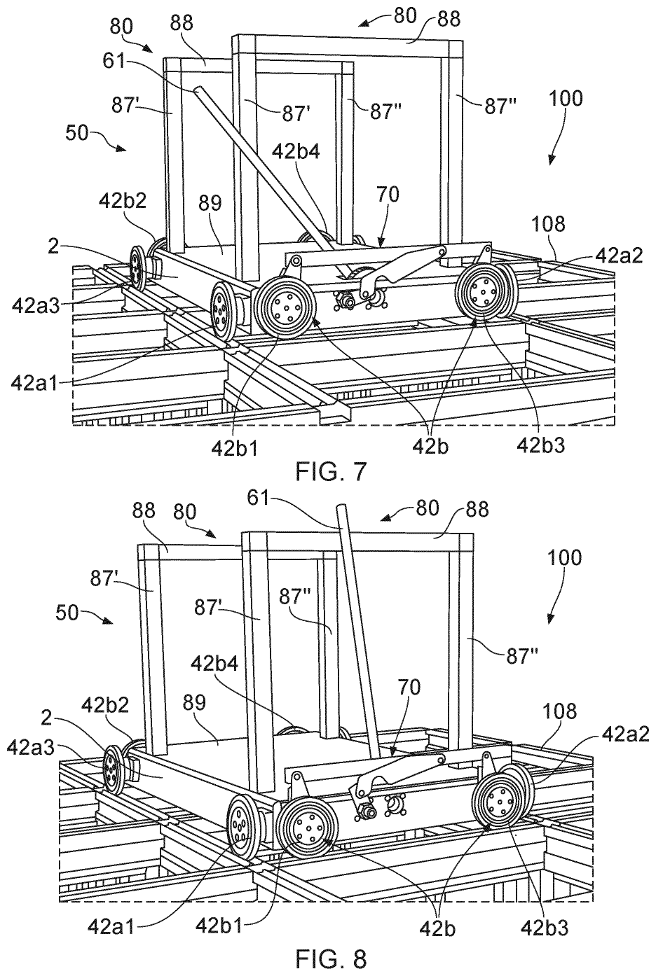

FIG. 8 is a side perspective view of a trolley 50 where the wheel lift mechanism 70 is in an intermediate position between the first position and the second position, wherein in the intermediate position a lowermost part of all of the wheels 42a1,42a2,42a3,42a4 in the first set of wheels 42a and all of the wheels 42b1,42b2,42b3,42b4 in the second set of wheels 42b are at the same level. I.e., in the intermediate position of FIG. 8, all of the wheels 42a1,42a2,42a3,42a4,42b1,42b2,42b3,42b4 of the trolley 50 are in contact with the underlying rail system 108. When comparing the position of the lever arm 61 in FIG. 8 with the position of the lever arm 61 in FIG. 6A and FIG. 7, respectively, it can be seen that the lever arm is in a position between the positions in FIGS. 6A and 7.

FIG. 9 is a perspective view from below of an actuator assembly 60 and the wheel lift mechanism 70 of the trolley 50, the actuator assembly 60 being manually operable by a human operator 10 for actuating the wheel lift mechanism 70 between the first position and the second position. As shown, the actuator assembly 60 comprises an actuator gear 62 and the lever arm 61 is connected to the actuator gear 62.

The wheel lift mechanism 70 is disclosed with a wheel lift gear 71 engaged with the actuator gear 62.

As shown, the actuator gear 62 has a larger gear circumference than the wheel lift gear 71.

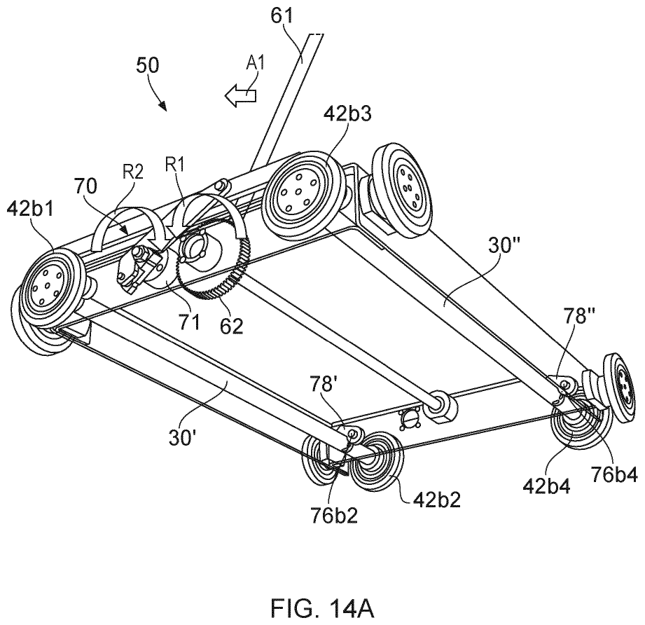

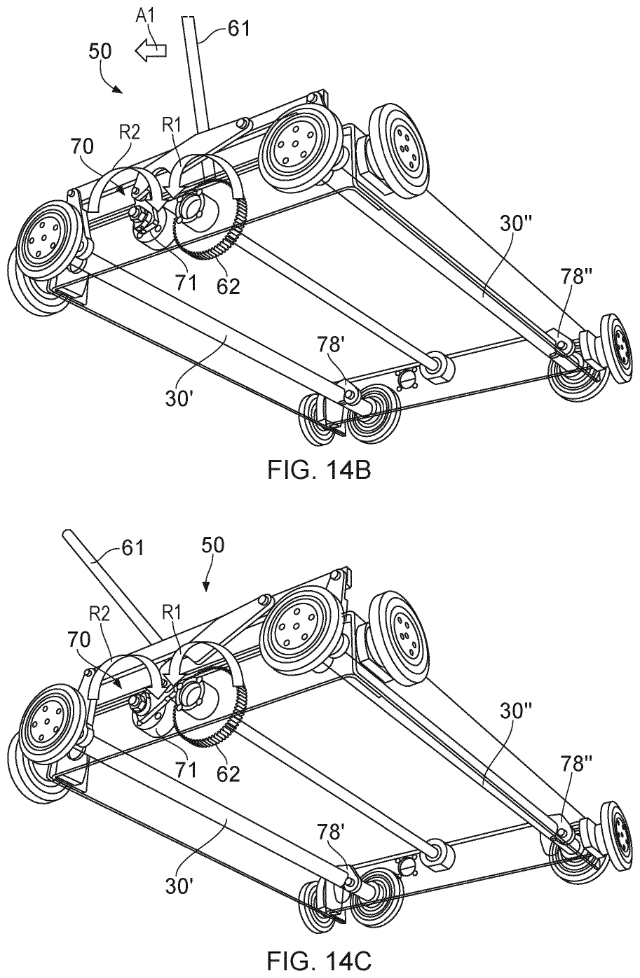

The first base element 65 is shown with grooves 73 for allowing vertical movement of a first shaft 30′ extending from the first wheel 42b1 of the second set of wheels to a second wheel 42b2 (not shown in FIG. 9, but see e.g. FIG. 10) in the second set of wheels on the opposite side of the trolley frame 51. Similarly, a second shaft 30″ extends from the third wheel 42b3 to the fourth wheel (not shown in FIG. 9, but see e.g. FIG. 14A) of the second set of wheels 42b.

An actuator shaft 63 extends from the first base element 65 to the second base element 66 supported by and actuator shaft support 64 on the opposite side of the trolley frame 51. It shall be noted that the actuator shaft 63 is not required as the actuator gear 62 does not have any other function than as a bearing. The actuator gear 62 might as well only be connected to the first base element 65 instead.

FIG. 10 is a side perspective view of the trolley 50 of FIG. 8 where the wheel lift mechanism 70 is in the intermediate position. This is illustrated by the lever arm 61 extending substantially vertically upwards. The trolley 50 is partly transparent such that the components below the support portion 89 is visible.

FIG. 11 is a bottom view of the actuator assembly 60 and the wheel lift mechanism 70 of the trolley 50. A centre axis C of the wheel lift gear 71 extends from an inside of the first base element 65 of the trolley frame 51 and to an outside of the first base element 65.

It can be seen that the first rocker link 74′ is fixedly connected to the first shaft 30′ via connection means 75. The first rocker link 74′ is rotatably connected to the first base element 65 of the trolley frame 51. The first wheel 42b1 of the second set of wheels is connected to the end of the first shaft 30′ (and, although not shown in FIG. 11, the second wheel 42b2 of the second set of wheels is connected to the opposite end of the first shaft 30′). This setup results in that if the first rocker link 74′ rotates upon actuation of the actuator assembly 60, the first shaft 30′ and thus the first wheel 42b1 and second wheel 42b2 of the second set of wheels moves up or down.

Similarly, the second rocker link 74″ is fixedly connected to the second shaft 30″ via connection means 75. The second rocker link 74″ is rotatably connected to the first base element 65 of the trolley frame 51. The third wheel 42b3 of the second set of wheels is connected to the end of the second shaft 30″ (and, although not shown in FIG. 11, the second wheel 42b2 of the second set of wheels is connected to the opposite end of the second shaft 30″). This setup results in that if the second rocker link 74″ rotates upon actuation of the actuator assembly 60, the second shaft 30′ and thus the third wheel 42b3 and fourth wheel 42b4 of the second set of wheels moves up or down.

Based on the fact that the first rocker link 74′ and the second rocker link 74″ is connected to the same coupling link 76, all four wheels 42b1,42b2,42b3,42b4 of the second set of wheels are moved up or down simultaneously.

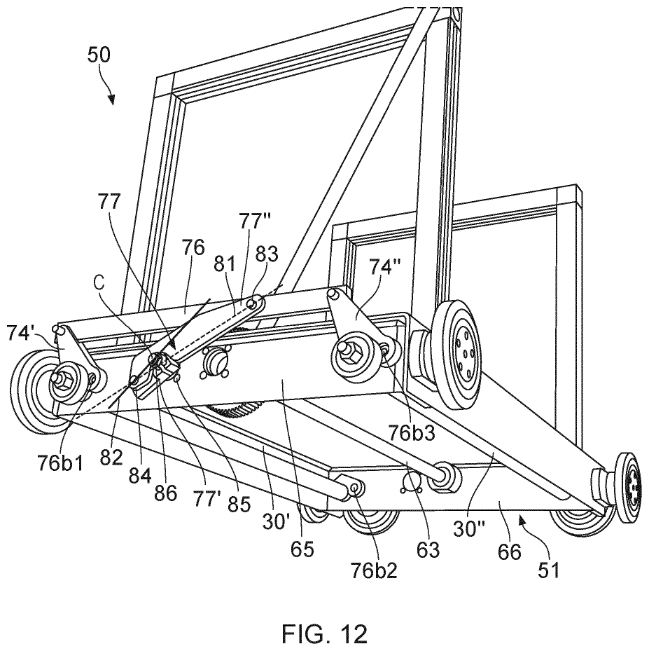

FIG. 12 is a side perspective view of the trolley 50 where two of the wheels in the first set of wheels have been omitted on purpose to better illustrate details of the different components forming part of the wheel lift mechanism 70 when the wheel lift mechanism 70 is in the first position in which the first set of wheels 42a is above the second set of wheels 42b such that the second set of wheels 42b is in contact with the rail system 108.

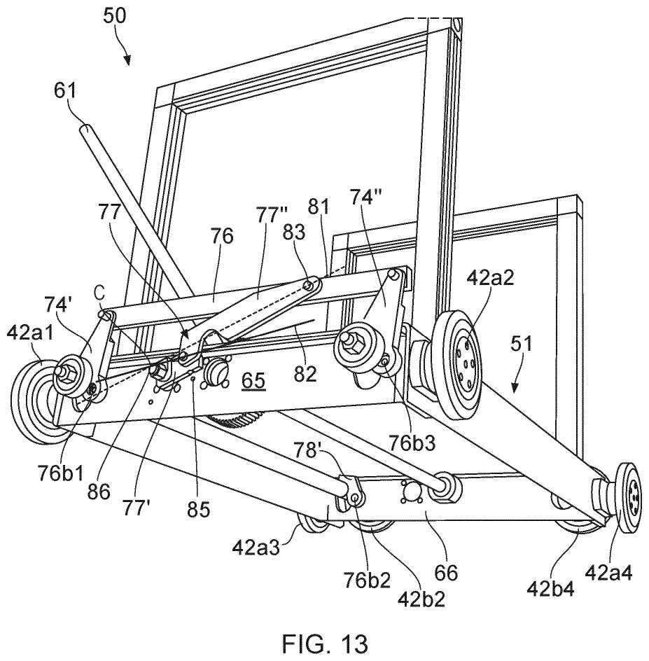

FIG. 13 is a side perspective view of the trolley 50 where two of the wheels in the first set of wheels have been omitted on purpose to better illustrate details of the different components forming part of the wheel lift mechanism 70 when the wheel lift mechanism 70 is in the second position in which the first set of wheels 42a is below the second set of wheels 42b such that the first set of wheels 42a is in contact with the rail system 108.

Referring to FIGS. 12 and 13, the trolley frame 51 is disclosed with a first stopper 85 for preventing rotation of the pivot link 77 in a first direction. The first stopper 85 forms the first end stop of the actuator assembly 60.

As disclosed, the first rocker link 74′ is rotationally connected to a first base element 65 of the trolley frame 51 in a first point of rotation 76b1 and the second rocker link 74″ is rotationally connected to the first base element 65 in a third point of rotation 76b3. Both the first rocker link 74′ and the second rocker link 74″ are pivotally connected to the coupling link 76 and pivotally connected to the trolley frame 51. The first rocker link 74′ is fixedly connected to a first end portion of the first shaft 30′ and the second rocker link 74″ is fixedly connected to a first end portion of the second shaft 30″.

As discussed in relation to FIG. 11, the centre axis C of the wheel lift gear 71 extends to an outside of the trolley frame 51. The centre axis C forms a second stopper 86 for preventing rotation of the of the pivot link 77 in a second direction which is opposite to the first direction. The second stopper 86 forms the second end stop of the actuator assembly 60.

The first stopper 85 and the second stopper 86 are arranged such that the first link 77′ rotates more than 180 degrees when moving from the first end stop to the second end stop.

As shown in FIGS. 12 and 13, a first linear axis 81 extends between a connection point 83 between the second link 77″ and the coupling link 76 and a connection point 84 between the first link 77′ and the second link 77″. Similarly, a second linear axis 82 extends between the connection point 84 between the first link 77′ and the second link 77″ and a center axis C of the wheel lift gear 71. When moving between the first end stop and the second end stop the first linear axis 81 and the second linear axis 82 cross each other twice (i.e. movement from the first end stop to the second end stop is more than 180 degrees rotation).

A first threshold position (not shown) is formed when the first linear axis 81 and the second linear axis 82 are in a first parallel position, and a second threshold position (not shown) is formed when the second linear axis 82 has rotated 180 degrees relative the first linear axis 81 to a second parallel position.

Referring to FIGS. 13 and 14A, the wheel lift mechanism 70 is further disclosed with a first bracket 78′ fixedly connected to a second end portion of the first shaft 30′ and pivotally connected to the second base element 66 of the trolley frame 51, and a second bracket 78″ (see FIG. 14A) which is fixedly connected to a second end portion of the second shaft 30″ and pivotally connected to second base element 66 of the trolley frame 51.

The first bracket 78′ is rotationally connected to a second base element 66 of the trolley frame 51 in second point of rotation 76b2 and the second bracket 78″ is rotationally connected to the second base element 66 in a fourth point of rotation 76b4.

FIGS. 14A-14C is a perspective view from below of an operational sequence of an actuator assembly 60 comprising a lever arm 61 used to operate the wheel lift mechanism 70 between the first position as shown in FIG. 14A, via the intermediate position as shown in FIG. 14B, and to the second position as shown in FIG. 14C, where some of the components of the trolley 50 have been omitted on purpose to better illustrate the relationship between the components in the respective first position, second position and intermediate position of the wheel lift mechanism 70.

Arrow A1 represents direction of movement of the lever arm 61, arrow R1 represents the direction of rotation of the actuator gear 62 and arrow R2 represents the direction of rotation of the wheel lift gear 71. When moving from the first position as shown in FIG. 14A towards the second position as shown in FIG. 14C, the lever arm 61 is moved in the direction indicated by arrow A1 resulting in a counter-clockwise rotation of the actuator gear 62 (indicated by arrow R1) which results in a clockwise rotation of the engaged wheel lift gear 71 (indicated by arrow R2).

In FIG. 14A the wheel lift mechanism 70 is in the first position in which the first set of wheels 42a is above the second set of wheels 42b such that the second set of wheels 42b is in contact with the rail system 108.

When comparing FIG. 14A and FIG. 14B, it can be seen the lever arm 61 has been moved in the direction of arrow A1 towards the second position of the wheel lift mechanism 70. In FIG. 14B the wheel lift mechanism 70 is in the intermediate position. In this intermediate position, a lowermost part of all of the wheels both in the first set of wheels and in the second set of wheels are in contact with the underlying rail system 108 (rail system not shown in FIG. 14B, but see e.g. FIG. 5A). When all wheels are in contact with the rails or tracks at the same time, stability of the trolley 50 is improved as well as unintentional movement of the trolley 50 is prevented. The intermediate position is typically the position used when the operator shall either perform maintenance on a malfunctioning container handling vehicle while sitting or standing on the trolley 50 or when leaving the trolley 50. The trolley 50 may thus be self-locking in the intermediate position as well such that a force has to be applied to raise or lower the second set of wheels relative the first set of wheels to enter the respective first or second position of the wheel lift mechanism 70.

When comparing FIG. 14B with FIG. 14C it can be seen the lever arm 61 has been moved from the intermediate position of FIG. 14B in the direction of arrow A1 to the second position of the wheel lift mechanism 70. In this second position of the wheel lift mechanism 70 the first set of wheels 42a is below the second set of wheels 42b such that the first set of wheels 42a is in contact with the rail system 108.

In order to be able to change to a perpendicular direction of movement of the trolley 50 on an underlying rail or track from the position in FIG. 14C, the lever arm 61 has to be moved in the opposite direction as compared to the direction of arrow A1 on FIGS. 14A and 14B.

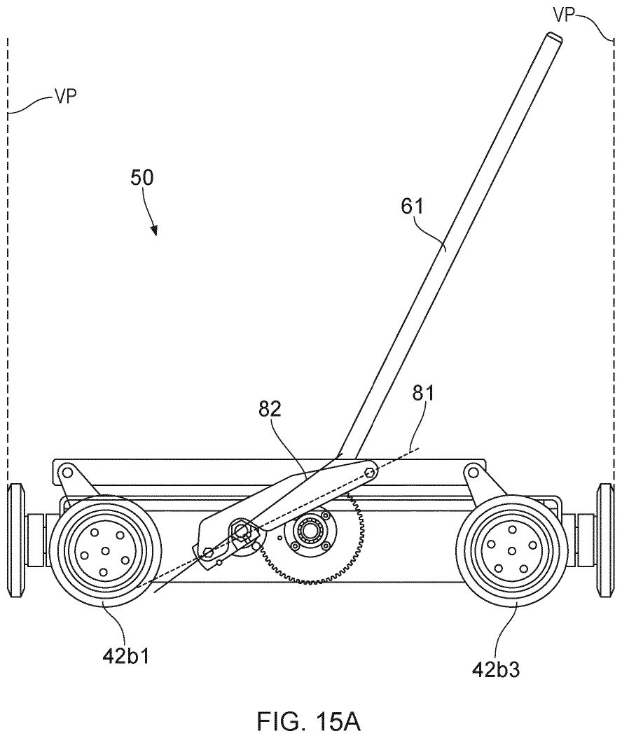

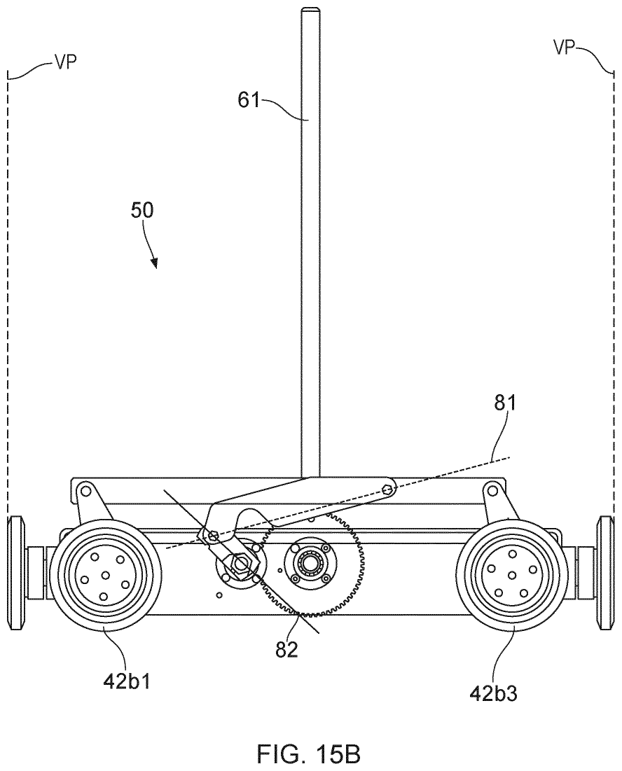

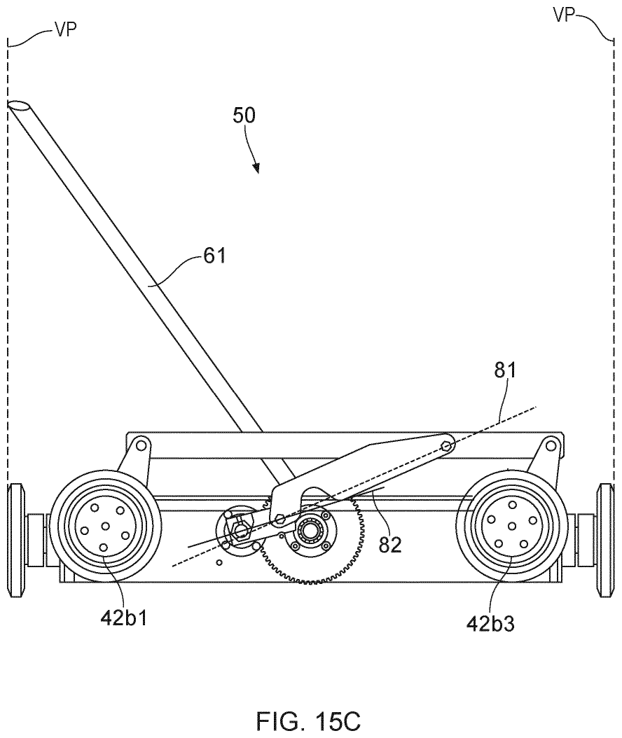

FIGS. 15A-15C is a side view of the operational sequence in FIGS. 14A-14C, where FIG. 15A shows FIG. 14A, FIG. 15B shows FIG. 14B and FIG. 15C shows FIG. 14C.

Further referring to FIGS. 15A-15C, the first end stop and the second end stop are arranged such that movement of the wheel lift mechanism 70 between the first position and the second position occurs inside a vertical projection VP of the trolley frame 51 (i.e. the wheeled base 2).

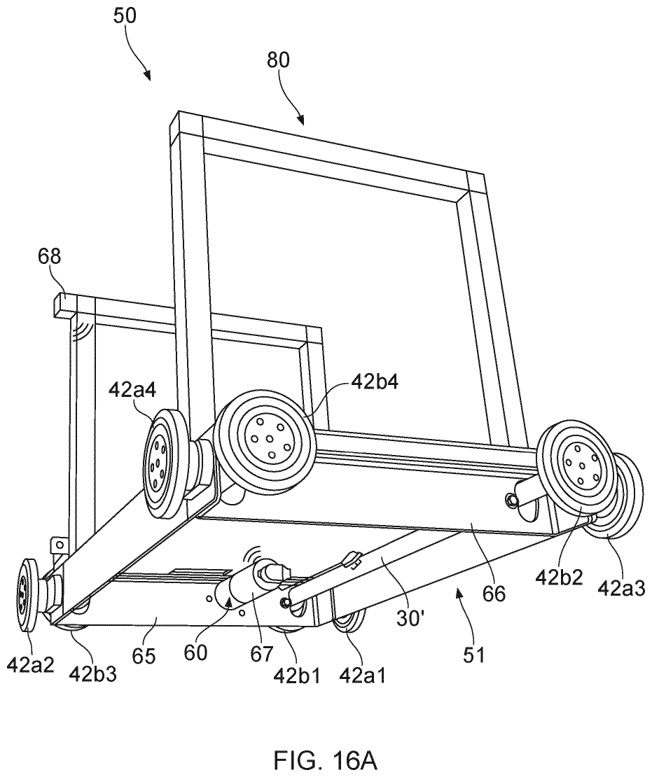

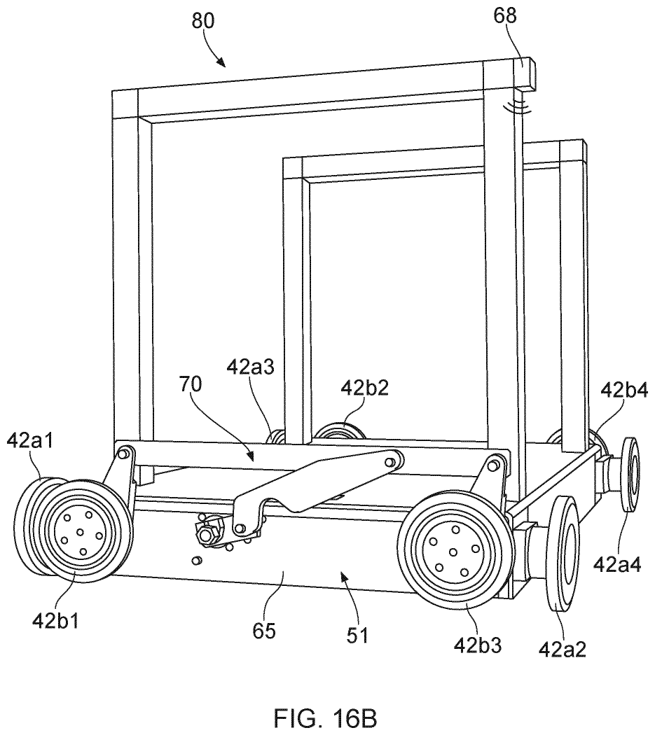

FIGS. 16A and 16B show a trolley 50 with an actuator assembly comprising a motor for actuating the wheel lift mechanism 70. When comparing the trolley in FIGS. 16A and 16B with the trolley 50 in FIGS. 5-15 the difference being the components of the actuator assembly 60, where the actuator wheel 62 has been removed and the lever 61 or lever arm 61 has been removed. In addition, the wheel gear 71 of the wheel lift mechanism 70 has been removed as well as the actuator shaft 63 and the actuator shaft support 64. Instead of the these removed components, it is disclosed an actuator assembly 60 comprising an actuator motor 67 and a control mechanism 68 for operating the actuator motor 67. The actuator motor 67 is connected to the wheel lift mechanism 70. The actuator motor 67 can be signally connected (wired or wireless (as indicated in FIG. 16A)) to the control mechanism 68. The control mechanism 68 can be one or more operating buttons 68 or operating pedals operable by a human operator such that the wheel lift mechanism 70 can be operated between the first position and the second position. The remaining components of the trolley 50 in FIGS. 16A and 16B are preferably equal to the ones described in relation to FIGS. 5-15 and will not be repeated herein.

The figures also disclose a storage system 1 comprising a frame structure 100, the frame structure 100 comprising upright members 102 and a two-dimensional rail system 108 arranged across the top of the upright members 102, the rail system 108 comprises a first set of parallel rails 110 arranged to guide movement of container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y across the top of the frame structure which is perpendicular to the first direction, the first and second sets of parallel rails 110,111 dividing the rail system 108 into a plurality of access openings 112 in the rail system 108 for lifting and lowering of a storage container 106 between a position above the rail system 108 and a position below the rail system 108, and wherein the storage system 1 comprises:
a plurality of container handling vehicles 201,301,401 (not shown in FIG. 5A, but see e.g. FIGS. 1-4) the container handling vehicle 201,301,401 comprises a first set of wheels 32a for moving the container handling vehicle upon the rail system in the first direction X and a second set of wheels 32b for moving the container handling vehicles 201,301,401 upon the rail system in the second direction Y; and
a trolley 50.

The trolley 50 may have a footprint equal to two access openings 112 (including rail width of the rails adjacent the access openings, i.e. the tracks directly below the first and second set of wheels 42a,42b). This occupied area equals to two grid cells 130 (see FIG. 5A).

The figures also shows a method of operating a trolley 50 with one or more of the features discussed above on a rail system 108 comprising a first set of parallel rails 110 arranged to guide movement of the trolley 50 in a first direction X across the top of a frame structure 100, and a second set of parallel rails 111 arranged perpendicular to the first set of rails 110 to guide movement of the trolley 50 in a second direction Y across the top of the frame structure which is perpendicular to the first direction X, wherein the method comprises a step of:
operating the actuator assembly 60 thereby actuating the wheel lift mechanism 70 between the first position and the second position, and vice versa.

The step of operating the actuator assembly 60 may comprise operating a lever 61 between a first end stop and a second end stop of the actuator assembly 60.

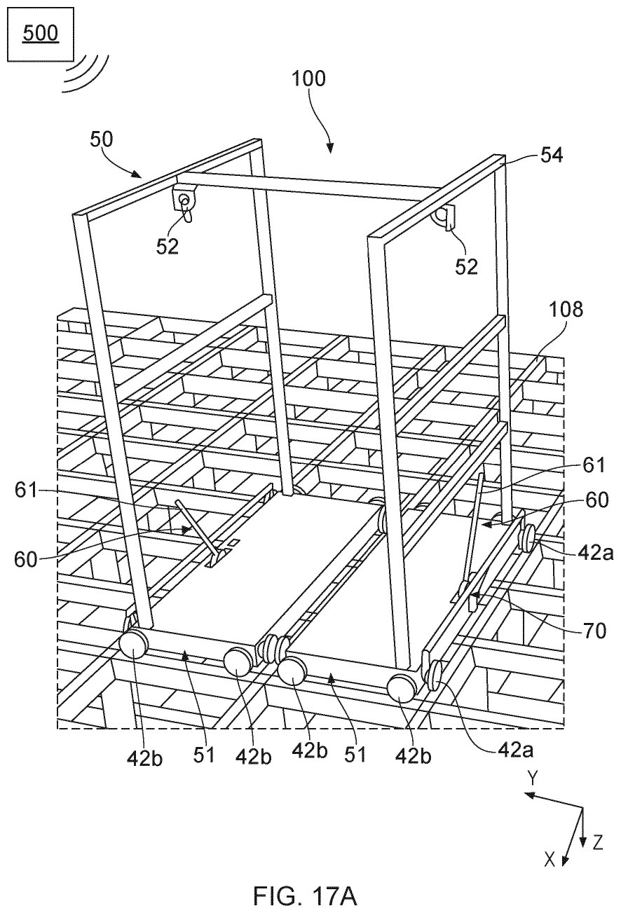

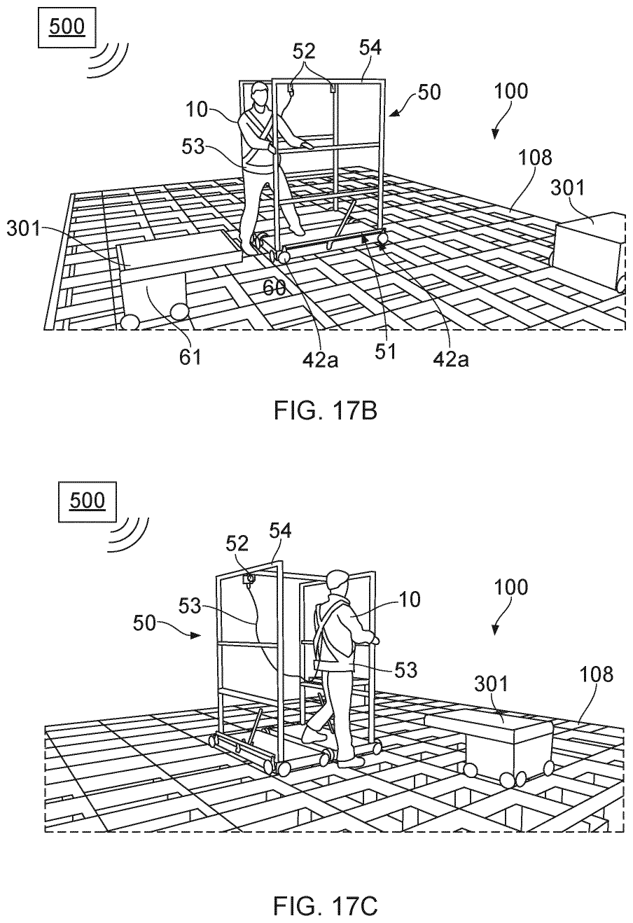

FIG. 17A is a side perspective view of a trolley with a footprint of 2×3 grid cells, the trolley having a structure 54 with a connection 52′,52″ for harness 53. The trolley 50 comprises two trolley frames 51 and a first set of wheels 42a and a second set of wheels 42b connected to the trolley frames 51. A wheel lift mechanism 70 is operable between a first position in which the first set of wheels 42a is above the second set of wheels 42b such that the second set of wheels 42b is in contact with the rail system 108, and a second position in which the first set of wheels 42a is below the second set of wheels 42b such that the first set of wheels 42a is in contact with the rail system 108. Two actuator assemblies 60 comprising a lever arm 61 manually operable by a human operator 10 for actuating the wheel lift mechanism 70 between the first position and the second position are shown. Details of the wheel lift mechanism 70 and the actuator assembly 60 are similar as described in relation to FIGS. 14A-14C and 15A-15C. Both of the actuator assemblies 60, i.e. the lever arms 61 disclosed in FIG. 17A, have to be operated in order to change direction of travel of the trolley on the rail system 108.

As mentioned above, the trolley 50 is formed of two equal trolley frames 51. The trolley frames 51 each has footprint equal to 3 grid cells (i.e. 1×3 grid cells). The trolley 50 comprises a structure 54 extending upwardly from the trolley frames 51. The structure 54 securely connects the trolley frames 51 to each other. The structure 54 is disclosed with a connection 52 for the harness 10 in the form of a first connection point 52 and a second connection point 52 arranged at a distance from each other.

FIG. 17B is a side perspective view of the trolley of FIG. 17A with an operator 10 thereon, the operator 10 being secured to the structure 54 with a harness 53. The operator 10 has one foot on one of the trolley frames 51 and the other foot on the set of parallel rails which is perpendicular to the direction of travel of the trolley 50.

The operator 10 has harness 53 on. The harness 53 is connected in one of the connection points 52 on the structure 54.

FIG. 17C is a similar view as FIG. 17B from an opposite angle.

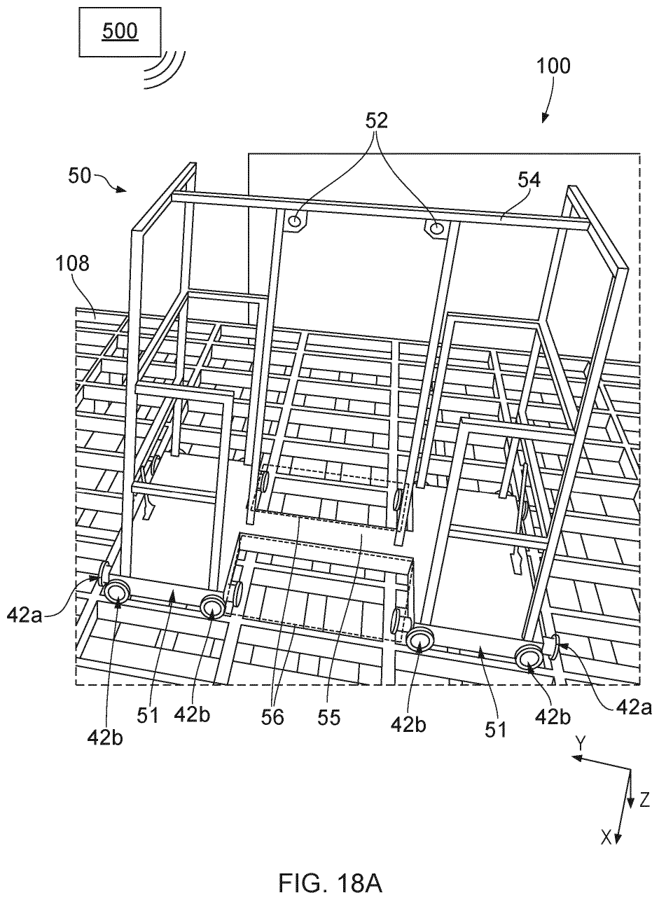

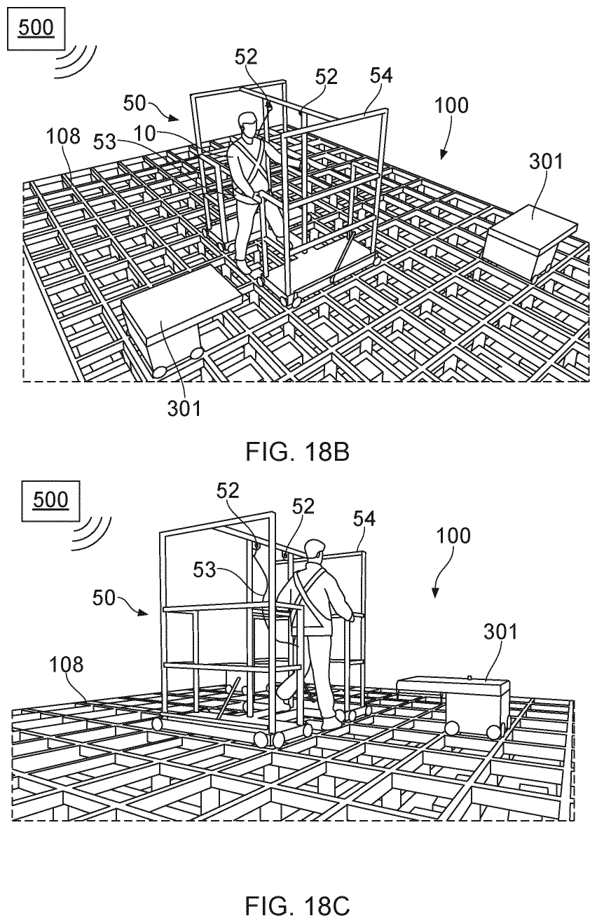

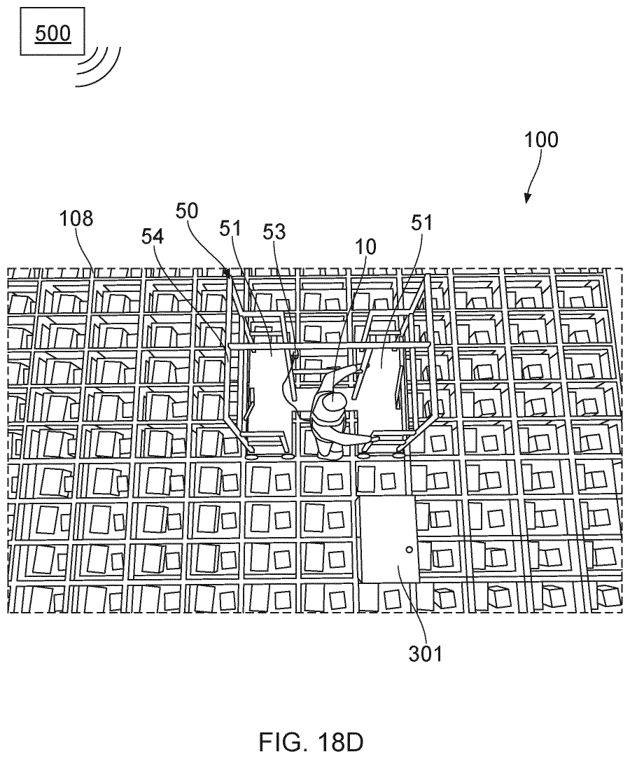

FIG. 18A is a side perspective view of a trolley with a footprint of 3×3 grid cells, the trolley 52 having a structure with a connection 52 for harness 53. The trolley 50 comprises two equal trolley frames 51 and a first set of wheels 42a and a second set of wheels 42b connected to the trolley frames 51. The trolley frames 51 are connected to each other through an intermediate base 55. The intermediate base 55 also serves as a spacer for the trolley frames 51 and has a smaller extension in at least one direction than the trolley frames 51 thereby providing a space 56 for a foot of the operator to push or kick against the underlying rails to gain speed of the trolley 50. In the trolley 50 of FIG. 18A, there are two spaces 56 i.e. one space 56 on each side of the intermediate base 55.

A wheel lift mechanism 70 is operable between a first position in which the first set of wheels 42a is above the second set of wheels 42b such that the second set of wheels 42b is in contact with the rail system 108, and a second position in which the first set of wheels 42a is below the second set of wheels 42b such that the first set of wheels 42a is in contact with the rail system 108. Two actuator assemblies 60 comprising a lever arm 61 manually operable by a human operator 10 for actuating the wheel lift mechanism 70 between the first position and the second position are shown. Details of the wheel lift mechanism 70 and the actuator assembly 60 are similar as described in relation to FIGS. 14A-14C and 15A-15C. Both of the actuator assemblies 60, i.e. the lever arms 61 disclosed in FIG. 18A, have to be operated in order to change direction of travel of the trolley on the rail system 108.

As mentioned above, the trolley 50 is formed of two equal trolley frames 51. The trolley frames 51 each has footprint equal to 3 grid cells (i.e. 1×3 grid cells) and are spaced from each other through the intermediate base 55. The trolley 50 comprises a structure 54 extending upwardly from the trolley frames 51. The structure 54 is disclosed with a connection 52 for the harness 10 in the form of a first connection point 52 and a second connection point 52 arranged at a distance from each other.

FIG. 18B is a side perspective view of the trolley of FIG. 18A with an operator 10 thereon, the operator 10 being secured to the structure 54 with a harness 53. The operator 10 has one foot on one of the trolley frames 51 and the other foot on the set of parallel rails which is perpendicular to the direction of travel of the trolley 50.

The operator 10 has harness 53 on. The harness 53 is connected in one of the connection points 52 on the structure 54.

FIG. 18C is a similar view as FIG. 18B from an opposite angle.

FIG. 18D is a top view of FIGS. 18B and 18C.

In the preceding description, various aspects of the independent claims have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

LIST OF REFERENCE NUMBERS

| | |
|---|---|
| 1 | Prior art automated storage and retrieval system |
| 2 | Wheeled base |
| 10 | Operator |
| 30′ | First shaft |
| 30″ | Second shaft |
| 42a | First set of wheels in first direction X |
| 42a1 | First wheel in first set of wheels |
| 42a2 | Second wheel in first set of wheels |
| 42a3 | Third wheel in first set of wheels |
| 42a4 | Fourth wheel in first set of wheels |
| 42b | Second set of wheels in second direction Y |
| 42b1 | First wheel in second set of wheels |
| 42b2 | Second wheel in second set of wheels |
| 42b3 | Third wheel in second set of wheels |
| 42b4 | Fourth wheel in second set of wheels |
| 50 | Trolley |
| 51 | Trolley frame |
| 52′, 52″ | Connection point |
| 53 | Harness |
| 54 | Structure |
| 55 | Intermediate base |
| 56 | Space |
| 60 | Actuator assembly |
| 61 | Lever/Lever arm |
| 62 | Actuator gear |
| 63 | Actuator shaft |
| 64 | Actuator shaft support |
| 65 | First base element |
| 66 | Second base element |
| 67 | Actuator motor |
| 68 | Control mechanism/ operating button |
| 70 | Wheel lift mechanism |
| 71 | Wheel lift gear |
| 73 | Groove |
| 74′ | First rocker link |
| 74′ | Second rocker link |
| 75 | Connection means |
| 76 | Coupling link |
| 76b1 | First point of rotation first rocker link (first wheel in second set of wheels) |
| 76b2 | Second point of rotation first bracket (second wheel in second set of wheels) |
| 76b3 | Third point of rotation second rocker link (third wheel in second set of wheels) |
| 76b4 | Fourth point of rotation second bracket (fourth wheel in second set of wheels) |
| 77 | Pivot link |
| 77′ | First link |
| 77″ | Second link |
| 78′ | First bracket |
| 78″ | Second bracket |
| 80 | Support(s) |
| 81 | First linear axis |
| 82 | Second linear axis |
| 83 | Connection point between the second link and the coupling link |
| 84 | Connection point between the first link and the second link |
| 85 | First stopper |
| 86 | Second stopper |
| 87′, 87″ | Vertical bar |
| 88 | Horizontal bar |
| 89 | Support portion |
| 100 | Frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel rails (in first direction (X)) |
| 111 | Second set of parallel rails (in second direction (Y)) |
| 112 | Access opening |
| 130 | Grid cell |
| 201 | Prior art container handling vehicle |
| 201a | Vehicle body of the container handling vehicle 201 |
| 201b | Drive means/wheel arrangement/first set of wheels in first direction (X) |
| 201c | Drive means/wheel arrangement/second set of wheels in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 500 | Control system |
| A | Section |
| C | Center axis of wheel lift gear |
| A1 | Movement direction of lever arm |
| R1 | Rotation direction of actuator gear |
| R2 | Rotation direction of wheel lift gear |
| PH | Horizontal plane |
| VP | Vertical projection of trolley frame/wheeled base |
| X | First direction |
| Y | Second direction |
| Z | Third direction |

1. A trolley (50) for operation on an automated storage and retrieval system (1), the automated storage and retrieval system (1) comprising a two-dimensional rail system (108) comprising a first set of parallel rails (110) in a horizontal plane (P_{H}) arranged to guide movement of container handling vehicles (201,301,401) in a first direction (X) across the top of a frame structure (100), and a second set of parallel rails (111) in the horizontal plane (P_{H}) arranged perpendicular to the first set of parallel rails (110) to guide movement of the container handling vehicles (201,301,401) in a second direction (Y) which is perpendicular to the first direction (X), wherein the trolley (50) comprises:
a trolley frame (51);
a first set of wheels (42a) for interaction with the rails (110) in the first direction (X) and a second set of wheels (42b) for interaction with the rails (111) in the second direction (Y), wherein the first set of wheels (42a) and the second set of wheels (42b) are connected to the trolley frame (51);
a wheel lift mechanism (70) operable between a first position in which the first set of wheels (42a) is above the second set of wheels (42b) such that the second set of wheels (42b) is in contact with the rail system (108), and a second position in which the first set of wheels (42a) is below the second set of wheels (42b) such that the first set of wheels (42a) is in contact with the rail system (108); and
an actuator assembly (60) manually operable by a human operator (10) for actuating the wheel lift mechanism (70) between the first position and the second position.

2. The trolley (50) according to claim 1, wherein the first set of wheels (42a) and the second set of wheels (42b) are non-motorized, and/or wherein the trolley frame (51) is a wheeled base (2), and optionally wherein the first end stop and the second end stop are arranged such that movement of the wheel lift mechanism (70) between the first position and the second position occurs inside a vertical projection of the wheeled base (2).

3. (canceled)

4. The trolley (50) according to claim 1, wherein the actuator assembly (60) comprises a lever (61), and/or wherein the lever (61) extends upwardly from the trolley frame (51), and/or wherein the actuator assembly (60) comprises an actuator gear (62) and wherein the lever arm (61) is connected to the actuator gear (62), and optionally wherein the wheel lift mechanism (70) comprises a wheel lift gear (71) engaged with the actuator gear (62), and optionally wherein the actuator gear (62) has a larger gear circumference than the wheel lift gear (71).

5-8. (canceled)

9. The trolley (50) according to claim 1, wherein the actuator assembly (60) comprises a first end stop representing the first position of the wheel lift mechanism (70) and a second end stop representing the second position of the wheel lift mechanism (70), and/or wherein the actuator assembly (60) comprises an intermediate position between the first position and the second position, and wherein, when in the intermediate position a lowermost part of all of the wheels in the first set of wheels (42a) and all of the wheels in the second set of wheels (42b) are at the same level.

10. The trolley (50) according to claim 1, wherein the wheel lift mechanism ( ) comprises:
a coupling link (76);
a first rocker link (74′) connecting the coupling link (76) and the trolley frame (51);
a second rocker link (74″) connecting the coupling link (76) and the trolley frame (51);
a pivot link (77) connecting the coupling link (76) and the wheel lift gear (71);
a first shaft (30′) extending between a first wheel (42b1) and a second wheel (42b2) of the second set of wheels (42b);
a second shaft (30″) extending between a third wheel (42b3) and a fourth wheel (42b4) of the second set of wheels (42b);
wherein both the first rocker link (74′) and the second rocker link (74″) are pivotally connected to the coupling link (76) and pivotally connected to the trolley frame (51), and wherein the first rocker link (74′) is fixedly connected to a first end portion of the first shaft (30′) and the second rocker link (74″) is fixedly connected to a first end portion of the second shaft (30″), and optionally wherein the wheel lift mechanism comprises:
a first bracket (78′) fixedly connected to a second end portion of the first shaft (30′) and pivotally connected to the trolley frame (51);
a second bracket (78″) fixedly connected to a second end portion of the second shaft (30″) and pivotally connected to the trolley frame (51).

11. (canceled)

12. The trolley (50) according to claim 10, wherein the pivot link (77) comprises a first link (77′) and a second link (77″), and wherein the first link (77′) is pivotally connected to the wheel lift gear (71) in a first end and pivotally connected to a first end of the second link (77″) in a second end, and wherein a second end of the second link (77″) is pivotally connected to the coupling link (76), and optionally wherein:
a first linear axis (81) extends between a connection point (83) between the second link (77″) and the coupling link (76) and a connection point (84) between the first link (77′) and the second link (77″); and
a second linear axis (82) extends between the connection point (84) between the first link (77′) and the second link (77″) and a center axis (C) of the wheel lift gear (71); and wherein when moving between the first end stop and the second end stop the first linear axis (81) and the second linear axis (82) cross each other twice, and
optionally wherein, a first threshold position is formed when the first linear axis (81) and the second linear axis (82) are in a first parallel position, and a second threshold position is formed when the second linear axis (82) has rotated 180 degrees relative the first linear axis (81) to a second parallel position.

13. The trolley (50) according to claim 12, wherein the first link (77′) and the second link (77″) rotate together.

14. The trolley (50) according to claim 10, wherein the trolley frame (51) comprises a first stopper (85) for preventing rotation of the pivot link (77) in a first direction, and wherein the first stopper (85) forms the first end stop of the actuator assembly (60) and optionally wherein a centre axis (C) of the wheel lift gear (71) extends to an outside of the trolley frame (51) forming a second stopper (86) for preventing rotation of the of the pivot link (77) in a second direction which is opposite to the first direction, and wherein the second stopper (86) forms the second end stop of the actuator assembly (60).

15. (canceled)

16. The trolley (50) according to claim 14, wherein the wheel lift mechanism (70) comprises a self-locking mechanism when in the first position and in the second position, and optionally wherein the first stopper (85) and the second stopper (86) are arranged such that the first link (77′) rotates more than 180 degrees when moving from the first end stop to the second end stop.

17-21. (canceled)

22. The trolley (50) according to claim 1, wherein the trolley (50) comprises a pair of supports (80) on opposite sides of the trolley frame (51), and optionally
wherein the supports (80) are formed of two vertical bars (87′,87″) and a horizontal bar (88), and wherein each of the vertical bars (87′,87″) are connected to the trolley frame (51) at a lower end thereof and to the horizontal bar (88) in an upper end thereof.

23. (canceled)

24. The trolley (50) according to claim 22, wherein the trolley (50) comprises a support portion (89) for supporting the operator (10), wherein the support portion (89) is arranged between the supports (80).

25. The trolley (50) according to claim 1, wherein the actuator assembly (60) comprises an actuator motor (67) and a control mechanism (68) for operating the actuator motor (67), and optionally wherein the actuator motor (67) is signally connected to the control mechanism (68).

26. (canceled)

27. The trolley (50) according to claim 25, wherein the control mechanism (68) comprises one or more operating buttons (68).

28. The trolley (50) according to claim 1, wherein the trolley (50) comprises a connection (52) for a harness (53) of the operator (10) to the trolley (50), and optionally wherein the trolley (50) comprises a structure (54), and wherein the structure (54) comprises the connection (52) for the harness.

29. (canceled)

30. The trolley (50) according to claim 28, wherein the connection (52) for the harness (53) is a fixed connection point (52), and optionally wherein the connection point (52) is a pad or padeye.

31. (canceled)

32. The trolley (50) according to claim 28, wherein the connection for the harness (53) is a spool or winch and/or wherein the connection (52) for the harness (53) is arranged in an upper part of the structure (54), and/or wherein the connection (52) for the harness is arranged within a vertical projection of the trolley frame (51) and/or wherein the connection (52) for the harness (10) comprises a first connection point (52) and a second connection point (52) arranged at a distance from each other.

33-35. (canceled)

36. A storage system (1) comprising a frame structure (100), the frame structure (100) comprising upright members (102) and a two-dimensional rail system (108) arranged across the top of the upright members (102), the rail system (108) comprises a first set of parallel rails (110) arranged to guide movement of container handling vehicles (201,301,401) in a first direction (X) across the top of the frame structure (100), and a second set of parallel rails (111) arranged perpendicular to the first set of rails (110) to guide movement of the container handling vehicles (201,301,401) in a second direction (Y) across the top of the frame structure which is perpendicular to the first direction, the first and second sets of parallel rails (110,111) dividing the rail system (108) into a plurality of access openings (112) in the rail system (108) for lifting and lowering of a storage container (106) between a position above the rail system (108) and a position below the rail system (108), and wherein the storage system (1) comprises:
a plurality of container handling vehicles (201,301,401) the container handling vehicle (201,301,401) comprises a first set of wheels (32a) for moving the container handling vehicle upon the rail system in the first direction (X) and a second set of wheels (32b) for moving the container handling vehicles (201,301,401) upon the rail system in the second direction (Y); and
a trolley (50) according to claim 1.

37. The storage system (1) according to claim 36, wherein the trolley (50) has a footprint equal to two access openings (112).

38. A method of operating a trolley (50) according to claim 1 on a rail system (108) comprising a first set of parallel rails (110) arranged to guide movement of the trolley (50) in a first direction (X) across the top of a frame structure (100), and a second set of parallel rails (111) arranged perpendicular to the first set of rails (110) to guide movement of the trolley (50) in a second direction (Y) across the top of the frame structure which is perpendicular to the first direction (X), wherein the method comprises a step of:
operating the actuator assembly (60) thereby actuating the wheel lift mechanism (70) between the first position and the second position, and vice versa.

39. The method according to claim 38, wherein the step of operating the actuator assembly (60) comprises operating a lever (61) between a first end stop and a second end stop of the actuator assembly (60), and optionally wherein the method comprises:
supporting the operator on the trolley (50) while moving the trolley (50) on top of the rail system (108); and
gaining speed on the trolley by the operator pushing or kicking on the first or second set of parallel rails which is perpendicular to the direction of travel, while being supported on the trolley (50)

40. (canceled)
